(19) United States
(12) Patent Application Publication
(10) Pub. No.: US 2014/0297802 A1
(43) Pub. Date: Oct. 2, 2014

(54) METHOD AND SYSTEM FOR LOCATION-BASED DELIVERY OF NOTICES OF ALARMS AND EVENTS

(71) Applicant: Schneider Electric Buildings, LLC, North Andover, MA (US)

(72) Inventor: Jie Liang, Nashua, NH (US)

(73) Assignee: Schneider Electric Building, LLC, North Andover, MA (US)

(21) Appl. No.: 14/360,075

(22) PCT Filed: Nov. 22, 2011
(86) PCT No.: PCT/US11/61806

§ 371 Date: May 22, 2014

(51) Int. Cl. H04L 29/08

(52) U.S. Cl. CPC H04L 67/18
USPC 709/217

(57) ABSTRACT

The system and method of location-based delivery of notice of an alarm and/or event incorporates location-based information in real time to facilitate alarm and/or event handling. The system and method ranks recipients in order of proximity to an alarm and/or event location. Recipients can be workstations, devices, or operators, and can be hard-coded or updated in real-time using GPS. The system and method can also rank recipients using multiple factors to provide an alarm and/or event handling system that is more efficient and more secure.

### FIELD OF THE INVENTION

The present invention relates to alarm and event handling systems and more particularly to the incorporation of location-based delivery of notice into an alarm and event handling system.

### BACKGROUND OF THE INVENTION

Alarm and event notice is meant to be delivered to operators for use in investigations. Timely responses are crucial to proper alarm and event handling. Currently in most systems, notice of alarms and events are delivered to a list of recipients. Recipients can be operators, workstations and/or devices. For a more efficient response, it would be advantageous to deliver notice of an alarm or event to operators, workstations, and/or devices, including mobile devices, nearest to the location where the alarm or event occurred.

### SUMMARY OF THE INVENTION

It has been recognized that introducing location-based delivery of notice into alarm and event delivery systems would greatly enhance the efficiency of the system and may even improve the safety and security of the area.

One aspect of the present invention is a system for delivery of notice of an alarm or event comprising, a sensor configured to indicate an alarm or event, wherein the alarm or event occurs at a known location; at least two recipients, wherein the location of each of the at least two recipients is capable of being determined in real time; and a controller configured to evaluate the location of each of the at least two recipients in reference to the location of the alarm or event in real time, wherein the controller is further configured to rank each of the at least two recipients in order of their proximity to the alarm or event.

In one embodiment is the system for delivery of notice of an alarm or event, wherein the controller is further configured to deliver notice of the alarm or event to the recipient whose location is closest to the location of the alarm or event.

In one embodiment is the system for delivery of notice of an alarm or event, wherein some of the at least two recipients' locations is fixed. In one embodiment is the system for delivery of notice of an alarm or event, wherein some of the at least two recipients' locations is determined using GPS.

In one embodiment is the system for delivery of notice of an alarm or event, wherein the at least two recipients are selected from the group consisting of operators, devices, and workstations.

In one embodiment is the system for delivery of notice of an alarm or event, wherein the controller is further configured to rank the at least two recipients based on factors other than proximity to the location of the event or alarm. In one embodiment is the system for delivery of notice of an alarm or event, wherein the factors are selected from the group consisting of work load, special skills, severity of the alarm and/or event, and priority of the alarm and/or event.

Another aspect of the present invention is a method of delivery of notice of an alarm or event comprising, identifying the location of an alarm or event; determining the location of each of at least two recipients in a facility in real time; listing the at least two recipients in order of proximity to the location of the event or alarm; and notifying some of the at least two recipients that attention is needed.

In one embodiment is the method or delivery of notice of an alarm or event, wherein the step of determining the location of some of the at least two recipients comprises gathering GPS information. In one embodiment is the method of delivery of notice of an alarm or event, wherein the step of determining the location of the at least two recipients further comprises the step of accessing a database containing the fixed location of some of the at least two recipients.

In one embodiment, the method of delivery of notice of an alarm or event further comprises the step of ranking the list of recipients based on factors other than proximity to the location of the event or alarm.

In one embodiment is the method of delivery of notice of an alarm or event, wherein the factors are selected from the group consisting of work load, special skills, severity of the alarm and/or event, and priority of the alarm and/or event.

In one embodiment is the method of delivery of notice of an alarm or event, wherein the at least two recipients are selected from the group consisting of operators, devices, and workstations.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a facility with various operators and workstations.

FIG. 2 shows a system of the present invention with alarm or event sources, controllers, and recipients.

FIG. 3 shows a system of the present invention using zones to calculate the distances between alarm or event sources and recipients.

### DETAILED DESCRIPTION OF THE INVENTION

It has been recognized that introducing location-based delivery of notice into alarm and event delivery systems would greatly enhance the efficiency of the system and may even improve the safety and security of the area. Efficiency would be increased if operators, workstations and/or devices, including mobile devices, nearest to the event and/or alarm were the ones to be notified and were the ones to respond. This is true for a few reasons. If a person is in distress or another time-sensitive incident has just occurred, it would be important to have the response-time as short as possible. This shorter response time would allow an operator to signal for help, or request back-up, if needed. Thus decreasing the time it takes for additional help or back-up to respond. Another reason it would be more efficient to incorporate location-based information is the alarm and event system would not unnecessarily dispatch operators and/or workstations located far away from the location of the event and/or alarm. Thus, the remote operators would be able to remain ready at their locations in case there were any intervening alarms or events. Operators would not waste valuable time traveling to a distant location of an incident only to find that other operators had already arrived and their services were not necessary. Furthermore, if a person or crew is dispatched and in the area, then there is an efficiency in any new events being routed to them. This holds true for general maintenance events as well.

The safety and security of a facility would likewise be improved if the events and/or alarms were handled more quickly. An operator might be able to catch sight of a fleeing suspect, gather important first impressions relevant to the cause of an incident, or help someone in imminent danger before other more remote operators are able to arrive in the area. Additionally, the security of the entire area would be not be disrupted by having distant operators and/or workstations respond to an event and/or alarm causing remote areas to be under-protected.

The system and method contemplates countless different types of events and alarms in the location-based delivery of notice event and alarm handling system. Events could be crimes, accidents, fires, lighting issues, IT and computer related issues, and the like. Alarms could be break-ins, fires, environmental conditions going out of range, IT and computer related issues, building safety alarms, such as motion, trip wires, invalid door access, and the like.

The method and system ranks recipients for use in the location-based delivery of notice alarm and/or event handling system. Notifications are generated by the system in real time. A recipient could be an operator (individual), a workstation, or a device, including mobile devices. When an alarm or event occurs, the system can automatically rank recipients based on their proximity to the location where the alarm and/or event occurred and a configuration engineer can have the option of selecting the nearest recipients. Or, when alarms and/or events occur, the nearest active recipient can be automatically selected by the system to receive the notification of the alarm and/or event. Depending on the alarm and/or event type, the system could sort the list of nearest recipients and rank them based on other characteristics or factors such as work load, severities of the alarm and/or event, priority of the alarm and/or event, such as for the type of response/work needed. The alarms and/or events could be prioritized by categories, including security, facility, IT, and the like.

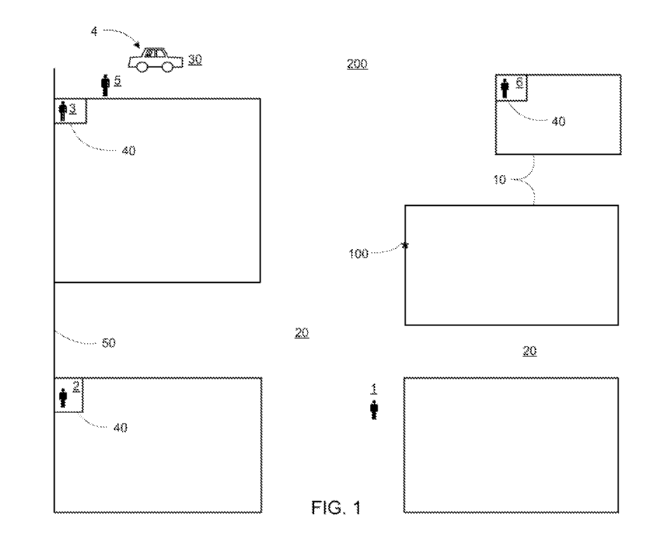

Alarm and event handling systems can monitor numerous areas which are spread out over a large area, and coordinate hundreds of operators, devices, and workstations. In the interest of simplicity, FIG. 1 represents a simplified example of a facility using a location-based delivery of notice alarm and event handling system, showing only a handful of operators and workstations.

Referring to FIG. 1, there are several operators 1-6 present in a facility 200. There are several buildings 10 as well as common areas 20 where operators might be found at any given time. Some operators are in vehicles 30, and some are in workstations 40. Some other operators 1, 5 are walking between buildings via the common areas 20. When an alarm or event occurs 100, each of the operators, workstations, and/or devices in the area are ranked in order of increasing distance from the alarm and/or event, in real time.

Still referring to FIG. 1, when the event and/or alarm commences, the system generates the ordered list of available recipients. The system could intelligently rank the recipients using numerous factors. For example, the closest workstation has Operator 6 stationed at it, the closest operator on foot is Operator 1, but depending on distances or other factors, Operator 4 in the vehicle 30 might be in the best position to respond first. The system could rank recipients based on whether an operator was on foot or in a vehicle, whether they had special skills, and the like. Also, depending on the type of event and/or alarm, even though the Operator 2 is near the front gate 50 and is not the closest in proximity to the incident, Operator 2 might also be notified so that he/she may respond accordingly (either by calling for backup, monitoring the ongoing response, and/or placing the facility in lock-down.

FIG. 1 is a very simplified diagram, but it is clear that generally it would not be efficient to have Operator 3 or 5 respond in this scenario. Not only would response time be increased if Operator 3 or 5 were the recipients to be notified, but the facility would then be under-protected in that area if there were an intervening alarm and/or event.

Many technologies could be used in gathering location information to prioritize a list of operators and/or workstations based on their proximity to an event and/or alarm. Workstations and devices could be at known locations (hard-coded) and would be easily sorted based on the location of the alarms. Operators and devices could be tracked using GPS, whether on foot or in a vehicle, and their locations could be incorporated into the ranking in real time.

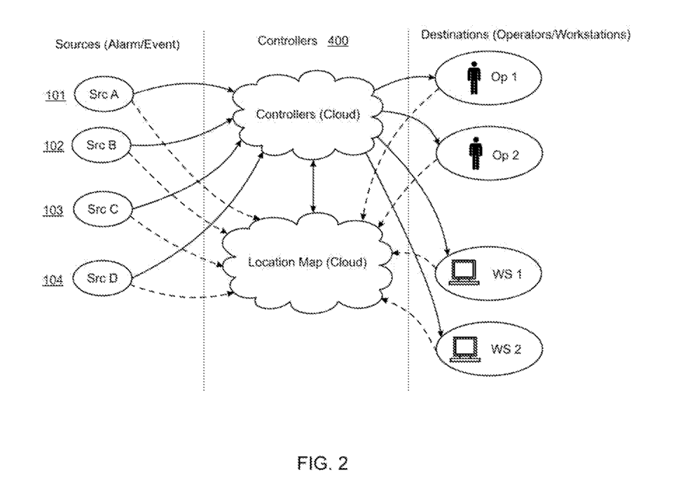

Referring to FIG. 2, the system and method of location-based notification of alarm and/or event information receives input from numerous sources of alarm and/or event information 101-104. There can be a controller 400 configured to evaluate the location of each of the recipients in reference to the location of the alarm or event in real time, wherein the controller is further configured to rank each of the at least two recipients in order of their proximity to the alarm or event as represented by the destination column. There, several operators and workstations are shown. It is also understood that recipients could be devices, either mobile or fixed, not shown.

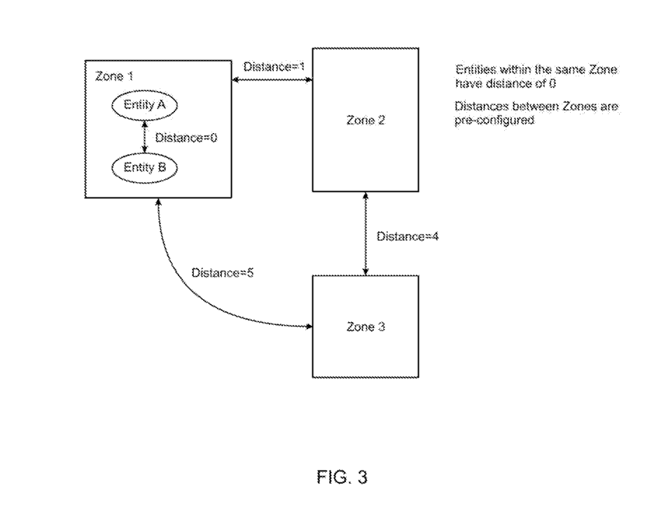

Referring to FIG. 3, the system and method of location-based notification of alarm and/or event information may also operate in zones of known distances. The distances between zones would be known and the presence of recipients in the same zone would be considered to have a distance of zero.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A system for delivery of notice of an alarm or event comprising,
a sensor configured to indicate an alarm or event, wherein the alarm or event occurs at a known location;
at least two recipients, wherein the location of each of the at least two recipients is capable of being determined in real time; and
a controller configured to evaluate the location of each of the at least two recipients in reference to the location of the alarm or event in real time, wherein the controller is further configured to rank each of the at least two recipients in order of their proximity to the alarm or event.

2. The system for delivery of notice of an alarm or event of claim 1, wherein the controller is further configured to deliver notice of the alarm or event to the recipient whose location is closest to the location of the alarm or event.

3. The system for delivery of notice of an alarm or event of claim 1, wherein some of the at least two recipients' locations is fixed.

4. The system for delivery of notice of an alarm or event of claim 1, wherein some of the at least two recipients' locations is determined using GPS.

5. The system for delivery of notice of an alarm or event of claim 1, wherein the at least two recipients are selected from the group consisting of operators, devices, and workstations.

6. The system for delivery of notice of an alarm or event of claim 1, wherein the controller is further configured to rank the at least two recipients based on factors other than proximity to the location of the event or alarm.

7. The system for delivery of notice of an alarm or event of claim 6, wherein the factors are selected from the group consisting of work load, special skills, severity of the alarm and/or event, and priority of the alarm and/or event.

8. A method of delivery of notice of an alarm or event comprising,
identifying the location of an alarm or event;
determining the location of each of at least two recipients in a facility in real time;
listing the at least two recipients in order of proximity to the location of the event or alarm; and
notifying some of the at least two recipients that attention is needed.

9. The method of delivery of notice of an alarm or event of claim 8, wherein the step of determining the location of some of the at least two recipients comprises gathering GPS information.

10. The method of delivery of notice of an alarm or event of claim 8, wherein the step of determining the location of the at least two recipients further comprises the step of accessing a database containing the fixed location of some of the at least two recipients.

11. The method of delivery of notice of an alarm or event of claim 8, further comprising the step of ranking the list of recipients based on factors other than proximity to the location of the event or alarm.

12. The method of delivery of notice of an alarm or event of claim 11, wherein the factors are selected from the group consisting of work load, special skills, severity of the alarm and/or event, and priority of the alarm and/or event.

13. The method of delivery of notice of an alarm or event of claim 8, wherein the at least two recipients are selected from the group consisting of operators, devices, and workstations.
